(19) United States
(12) Patent Application Publication
(10) Pub. No.: US 2018/0124678 A1
(43) Pub. Date: May 3, 2018

(54) INFORMATION TRANSMISSION METHOD, DEVICE, AND SYSTEM

(71) Applicant: Huawei Technologies Co., Ltd., Shenzhen, Guangdong (CN)

(72) Inventor: Jian Wang, Beijing (CN)

(21) Appl. No.: 15/570,290

(22) PCT Filed: Apr. 28, 2015
(86) PCT No.: PCT/CN2015/077681

§ 371 Date: Oct. 27, 2017

(51) Int. Cl. H04W 40/24; H04W 64/00

(52) U.S. Cl. CPC H04W 40/248; H04W 88/04; H04W 64/006; H04W 76/023

(57) ABSTRACT

The present invention discloses an information transmission method, a device, and a system, relates to the communications field, and resolves a problem in the prior art that in a D2D scenario, a terminal device cannot perform D2D communication due to a relatively long distance or a relatively significant change in channel quality. A specific solution is: generating, by a first device, a first scrambling sequence according to a first scrambling seed, where the first scrambling seed is generated according to a relay level or an information source of first information, scrambling the first information according to the first scrambling sequence, and sending the first information. The present invention is applied to information transmission.

### CROSS-REFERENCE TO RELATED APPLICATIONS

This application is a national stage of International Application No. PCT/CN2015/077681, filed on Apr. 28, 2015, which is hereby incorporated by reference in its entirety.

### TECHNICAL FIELD

The present invention relates to the communications field, and in particular, to an information transmission method, a device, and a system.

### BACKGROUND

With development of communications technologies, data transmitted in a wireless communications system is growing increasingly. A higher throughput and higher transmission efficiency are required to meet a user requirement. How to improve resource utilization and improve data transmission efficiency by using limited time-frequency resources becomes a critical problem. Cell resources are reused in a D2D ProSe (Device to Device Proximity Service, device to device proximity service), so that terminal devices can directly communicate with each other, improving resource utilization and a network capacity.

In the prior art, a D2D scenario in an LTE (Long Term Evolution, Long Term Evolution) system is used as an example. In a D2D system, direct communication is performed between terminal devices, such as mobile phones or tablet computers, the devices are more mobile, and a channel status changes quickly. If two terminal devices that perform direct communication are relatively far from each other or a change in channel quality is relatively significant, the two terminal devices cannot perform D2D communication.

### SUMMARY

Embodiments of the present invention provide an information transmission method, a device, and a system, so as to resolve a problem that in a D2D scenario, an error occurs during data receiving because a terminal device cannot identify a sequence relationship between data.

To achieve the foregoing objective, the following technical solutions are used in the embodiments of the present invention:

According to a first aspect, an embodiment of the present invention provides a first device, which is applied to a device to device D2D scenario, where the first device includes a processor, a memory, a bus, and a transmitter, and the processor, the memory, and the transmitter are interconnected by using the bus;

the processor is configured to: generate a first scrambling sequence according to a first scrambling seed, and scramble the first information according to the first scrambling sequence, where the first scrambling seed is generated according to a relay level or an information source of the first information, the relay level of the first information is used to indicate a quantity of relay devices that the first information has passed by before being transmitted to a receive end, and the information source of the first information is used to indicate a location of a starting device for transmitting the first information; and

the transmitter is configured to send the first information scrambled by the processor.

With reference to the first aspect, in a first possible implementation, the first device further includes a receiver, and the receiver is interconnected to the processor, the memory, and the transmitter by using the bus;

the receiver is configured to: receive second information when a relay level of the second information is a preset level or an information source of the second information is a preset source, where the relay level of the second information is used to indicate a quantity of relay devices that the second information has passed by before being transmitted to the first device, and the information source of the second information is used to indicate a location of a starting device for transmitting the second information; and

the processor is further configured to: generate a second scrambling sequence according to a second scrambling seed, and descramble the second information according to the second scrambling sequence, where the second scrambling seed is generated according to the relay level or information source of the second information received by the receiver.

With reference to the first possible implementation of the first aspect, in a second possible implementation of the first aspect,

the processor is further configured to: when the second scrambling seed indicates the relay level of the second information, use the relay level of the second information plus 1 as a new relay level of the second information, generate a third scrambling seed according to the new relay level of the second information, generate a third scrambling sequence according to the third scrambling seed, and scramble the second information according to the third scrambling sequence; and

the transmitter is further configured to send the second information scrambled by the processor.

With reference to any one of the first aspect, or the first or the second possible implementation of the first aspect, in a third possible implementation of the first aspect,

N bits in the first scrambling seed are used to indicate the relay level or information source of the first information, and N is an integer greater than 0.

With reference to any one of the first aspect, or the first to the third possible implementations of the first aspect, in a fourth possible implementation of the first aspect,

the first scrambling seed includes a physical layer identity ID, and the physical layer ID is used to indicate the relay level or information source of the first information.

With reference to the fourth possible implementation of the first aspect, in a fifth possible implementation of the first aspect, the physical layer ID is used to indicate the relay level of the first information; and

when a sequence of the physical layer ID included in the first scrambling seed is a first sequence, the relay level of the first information is 0; when the sequence of the physical layer ID included in the first scrambling seed is an (i+1)^{th} sequence, the relay level of the first information is i, where i is a positive integer.

With reference to the fourth possible implementation of the first aspect, in a sixth possible implementation of the first aspect, the physical layer ID is used to indicate the relay level of the first information; and

when an offset of the physical layer ID included in the first scrambling seed is a first offset, the relay level of the first information is 0; when the offset of the physical layer ID included in the first scrambling seed is an (i+1)^{th} offset, the relay level of the first information is i, where i is a positive integer.

With reference to any one of first aspect, or the first to the sixth possible implementations of the first aspect, in a seventh possible implementation of the first aspect,

the first information is control signaling, data information, or a discovery signal.

With reference to any one of the first aspect, or the first to the seventh possible implementations of the first aspect, in an eighth possible implementation of the first aspect,

the location of the starting device for transmitting the first information is within a network coverage area or outside a network coverage area.

According to a second aspect, an embodiment of the present invention provides a first device, which is applied to a device to device D2D scenario, where the second device includes a processor, a memory, a bus, and a receiver, and the processor, the memory, and the receiver are interconnected by using the bus;

the receiver is configured to: receive first information when a relay level of the first information is a preset level or an information source of the first information is a preset source, where the relay level of the first information is used to indicate a quantity of relay devices that the first information has passed by before being transmitted to the second device, and the information source of the first information is used to indicate a location of a starting device for transmitting the first information; and

the processor is configured to: generate a first scrambling sequence according to a first scrambling seed, and descramble the first information according to the first scrambling sequence, where the first scrambling seed is generated according to the relay level or information source of the first information.

With reference to the second aspect, in a first possible implementation, the second device further includes a transmitter, and the transmitter is interconnected to the processor, the memory, and the transmitter by using the bus;

the processor is further configured to: generate a second scrambling sequence according to a second scrambling seed, and scramble the second information according to the second scrambling sequence, where the second scrambling seed is generated according to a relay level or an information source of the second information, the relay level of the second information is used to indicate a quantity of relay devices that the second information has passed by before being transmitted to a receive end, and the information source of the second information is used to indicate a location of a starting device for transmitting the second information; and

the transmitter is configured to send the second information scrambled by the processor.

With reference to the second aspect, in a second possible implementation of the second aspect, the second device further includes a transmitter, and the transmitter is interconnected to the processor, the memory, and the transmitter by using the bus;

the processor is further configured to: when the first scrambling seed indicates the relay level of the first information, use the relay level of the first information plus 1 as a new relay level of the first information, generate a third scrambling seed according to the new relay level of the first information, generate a third scrambling sequence according to the third scrambling seed, and scramble the first information according to the third scrambling sequence; and

the transmitter is configured to send the first information scrambled by the processor.

With reference to any one of the second aspect, or the first or the second possible implementation of the second aspect, in a third possible implementation of the second aspect,

N bits in the first scrambling seed are used to indicate the relay level or information source of the first information, and N is an integer greater than 0.

With reference to any one of the second aspect, or the first to the third possible implementations of the second aspect, in a fourth possible implementation of the second aspect,

the first scrambling seed includes a physical layer identity ID, and the physical layer ID is used to indicate the relay level or information source of the first information.

With reference to the fourth possible implementation of the second aspect, in a fifth possible implementation of the second aspect, the physical layer ID is used to indicate the relay level of the first information; and

when a sequence of the physical layer ID included in the first scrambling seed is a first sequence, the relay level of the first information is 0; when the sequence of the physical layer ID included in the first scrambling seed is an (i+1)^{th} sequence, the relay level of the first information is i, where i is a positive integer.

With reference to the fourth possible implementation of the second aspect, in a sixth possible implementation of the second aspect, the physical layer ID is used to indicate the relay level of the first information; and

when an offset of the physical layer ID included in the first scrambling seed is a first offset, the relay level of the first information is 0; when the offset of the physical layer ID included in the first scrambling seed is an (i+1)^{th} offset, the relay level of the first information is i, where i is a positive integer.

With reference to any one of the second aspect, or the first to the sixth possible implementations of the second aspect, in a seventh possible implementation of the second aspect,

the first information is control signaling, data information, or a discovery signal.

With reference to any one of the first aspect, or the first to the seventh possible implementations of the first aspect, in an eighth possible implementation of the first aspect,

the location of the starting device for transmitting the first information is within a network coverage area or outside a network coverage area.

According to a third aspect, an embodiment of the present invention provides a first device, which is applied to a device to device D2D scenario, and includes:

a scrambling code unit, configured to generate a first scrambling sequence according to a first scrambling seed, where the first scrambling seed is generated according to a relay level or an information source of first information, the relay level of the first information is used to indicate a quantity of relay devices that the first information has passed by before being transmitted to a receive end, and the information source of the first information is used to indicate a location of a starting device for transmitting the first information;

a scrambling unit, configured to scramble the first information according to the first scrambling sequence generated by the scrambling code unit; and

a sending unit, configured to send the first information scrambled by the scrambling unit.

With reference to the third aspect, in a first possible implementation,

the first device further includes a receiving unit, configured to: receive second information when a relay level of the second information is a preset level or an information source of the second information is a preset source, where the relay level of the second information is used to indicate a quantity of relay devices that the second information has passed by before being transmitted to the first device, and the information source of the second information is used to indicate a location of a starting device for transmitting the second information;

the scrambling code unit is further configured to generate a second scrambling sequence according to a second scrambling seed; and

the first device further includes a descrambling unit, configured to descramble, according to the second scrambling sequence generated by the scrambling code unit, the second information received by the receiving unit, where the second scrambling seed is generated according to the relay level or information source of the second information received by the receiver.

With reference to the first possible implementation of the third aspect, in a second possible implementation of the third aspect,

the scrambling code unit is further configured to: when the second scrambling seed indicates the relay level of the second information, use the relay level of the second information plus 1 as a new relay level of the second information, generate a third scrambling seed according to the new relay level of the second information, and generate a third scrambling sequence according to the third scrambling seed;

the scrambling unit is configured to scramble the second information according to the third scrambling sequence generated by the scrambling code unit; and

the sending unit is further configured to send the second information scrambled by the scrambling unit.

With reference to any one of the third aspect, or the first or the second possible implementation of the third aspect, in a third possible implementation of the third aspect,

N bits in the first scrambling seed are used to indicate the relay level or information source of the first information, and N is an integer greater than 0.

With reference to any one of the third aspect, or the first to the third possible implementations of the third aspect, in a fourth possible implementation of the third aspect,

the first scrambling seed includes a physical layer identity ID, and the physical layer ID is used to indicate the relay level or information source of the first information.

With reference to the fourth possible implementation of the third aspect, in a fifth possible implementation of the third aspect, the physical layer ID is used to indicate the relay level of the first information; and

when a sequence of the physical layer ID included in the first scrambling seed is a first sequence, the relay level of the first information is 0; when the sequence of the physical layer ID included in the first scrambling seed is an (i+1)^{th} sequence, the relay level of the first information is i, where i is a positive integer.

With reference to the fourth possible implementation of the third aspect, in a sixth possible implementation of the third aspect, the physical layer ID is used to indicate the relay level of the first information; and

when an offset of the physical layer ID included in the first scrambling seed is a first offset, the relay level of the first information is 0; when the offset of the physical layer ID included in the first scrambling seed is an (i+1)^{th} offset, the relay level of the first information is i, where i is a positive integer.

With reference to any one of the third aspect, or the first to the sixth possible implementations of the third aspect, in a seventh possible implementation of the third aspect,

the first information is control signaling, data information, or a discovery signal.

With reference to any one of the first aspect, or the first to the seventh possible implementations of the first aspect, in an eighth possible implementation of the first aspect,

the location of the starting device for transmitting the first information is within a network coverage area or outside a network coverage area.

According to a fourth aspect, an embodiment of the present invention provides a first device, which is applied to a device to device D2D scenario, and includes:

a receiving unit, configured to: receive first information when a relay level of the first information is a preset level or an information source of the first information is a preset source, where the relay level of the first information is used to indicate a quantity of relay devices that the first information has passed by before being transmitted to the second device, and the information source of the first information is used to indicate a location of a starting device for transmitting the first information;

a scrambling code unit, configured to generate a first scrambling sequence according to a first scrambling seed, where the first scrambling seed is generated according to the relay level or information source of the first information; and

a descrambling unit, configured to descramble the first information according to the first scrambling sequence generated by the scrambling code unit.

With reference to the fourth aspect, in a first possible implementation,

the scrambling code unit is further configured to generate a second scrambling sequence according to a second scrambling seed, where the second scrambling seed is generated according to a relay level or an information source of second information, the relay level of the second information is used to indicate a quantity of relay devices that the second information has passed by before being transmitted to a receive end, and the information source of the second information is used to indicate a location of a starting device for transmitting the second information;

the second device further includes a scrambling unit, configured to scramble the second information according to the second scrambling sequence generated by the scrambling code unit; and

the second device further includes a sending unit, configured to send the second information scrambled by the scrambling unit.

With reference to the fourth aspect, in a second possible implementation of the fourth aspect,

the scrambling code unit is further configured to: when the first scrambling seed indicates the relay level of the first information, use the relay level of the first information plus 1 as a new relay level of the first information, generate a third scrambling seed according to the new relay level of the first information, and generate a third scrambling sequence according to the third scrambling seed;

the second device further includes a scrambling unit, configured to scramble the first information according to the third scrambling sequence generated by the scrambling code unit; and

the second device further includes a sending unit, configured to send the first information scrambled by the scrambling unit.

With reference to any one of the fourth aspect, or the first or the second possible implementation of the fourth aspect, in a third possible implementation of the fourth aspect,

N bits in the first scrambling seed are used to indicate the relay level or information source of the first information, and N is an integer greater than 0.

With reference to any one of the fourth aspect, or the first to the third possible implementations of the fourth aspect, in a fourth possible implementation of the fourth aspect,

the first scrambling seed includes a physical layer identity ID, and the physical layer ID is used to indicate the relay level or information source of the first information.

With reference to the fourth possible implementation of the fourth aspect, in a fifth possible implementation of the fourth aspect, the physical layer ID is used to indicate the relay level of the first information; and

when a sequence of the physical layer ID included in the first scrambling seed is a first sequence, the relay level of the first information is 0; when the sequence of the physical layer ID included in the first scrambling seed is an (i+1)^{th} sequence, the relay level of the first information is i, where i is a positive integer.

With reference to the fourth possible implementation of the fourth aspect, in a sixth possible implementation of the fourth aspect, the physical layer ID is used to indicate the relay level of the first information; and

when an offset of the physical layer ID included in the first scrambling seed is a first offset, the relay level of the first information is 0; when the offset of the physical layer ID included in the first scrambling seed is an (i+1)^{th} offset, the relay level of the first information is i, where i is a positive integer.

With reference to any one of the fourth aspect, or the first to the sixth possible implementations of the fourth aspect, in a seventh possible implementation of the fourth aspect,

the first information is control signaling, data information, or a discovery signal.

With reference to any one of the first aspect, or the first to the seventh possible implementations of the first aspect, in an eighth possible implementation of the first aspect,

the location of the starting device for transmitting the first information is within a network coverage area or outside a network coverage area.

According to a fifth aspect, an embodiment of the present invention provides an information transmission method, which is applied to a device to device D2D scenario, and includes:

generating, by a first device, a first scrambling sequence according to a first scrambling seed, where the first scrambling seed is generated according to a relay level or an information source of first information, the relay level of the first information is used to indicate a quantity of relay devices that the first information has passed by before being transmitted to a receive end, and the information source of the first information is used to indicate a location of a starting device for transmitting the first information; and

scrambling, by the first device, the first information according to the first scrambling sequence, and sending the first information.

With reference to the fifth aspect, in a first possible implementation, the method further includes:

receiving, by the first device, second information when a relay level of the second information is a preset level or an information source of the second information is a preset source, where the relay level of the second information is used to indicate a quantity of relay devices that the second information has passed by before being transmitted to the first device, and the information source of the second information is used to indicate a location of a starting device for transmitting the second information;

generating, by the first device, a second scrambling sequence according to a second scrambling seed, where the second scrambling seed is generated according to the relay level or information source of the second information; and

descrambling, by the first device, the second information according to the second scrambling sequence.

With reference to the first possible implementation of the fifth aspect, in a second possible implementation of the fifth aspect,

when the second scrambling seed indicates the relay level of the second information,

after the descrambling, by the first device, the second information according to the second scrambling sequence, the method further includes:

using, by the first device, the relay level of the second information plus 1 as a new relay level of the second information, generating a third scrambling seed according to the new relay level of the second information, and generating a third scrambling sequence according to the third scrambling seed; and

scrambling, by the first device, the second information according to the third scrambling sequence, and sending the second information.

With reference to any one of the fifth aspect, or the first or the second possible implementation of the fifth aspect, in a third possible implementation of the fifth aspect,

N bits in the first scrambling seed are used to indicate the relay level or information source of the first information, and N is an integer greater than 0.

With reference to any one of the fifth aspect, or the first to the third possible implementations of the fifth aspect, in a fourth possible implementation of the fifth aspect,

the first scrambling seed includes a physical layer identity ID, and the physical layer ID is used to indicate the relay level or information source of the first information.

With reference to the fourth possible implementation of the fifth aspect, in a fifth possible implementation of the fifth aspect, the physical layer ID is used to indicate the relay level of the first information; and

when a sequence of the physical layer ID included in the first scrambling seed is a first sequence, the relay level of the first information is 0; when the sequence of the physical layer ID included in the first scrambling seed is an (i+1)^{th} sequence, the relay level of the first information is i, where i is a positive integer.

With reference to the fourth possible implementation of the fifth aspect, in a sixth possible implementation of the fifth aspect, the physical layer ID is used to indicate the relay level of the first information; and

when an offset of the physical layer ID included in the first scrambling seed is a first offset, the relay level of the first information is 0; when the offset of the physical layer ID included in the first scrambling seed is an (i+1)^{th} offset, the relay level of the first information is i, where i is a positive integer.

With reference to any one of the fifth aspect, or the first to the sixth possible implementations of the fifth aspect, in a seventh possible implementation of the fifth aspect,

the first information is control signaling, data information, or a discovery signal.

With reference to any one of the first aspect, or the first to the seventh possible implementations of the first aspect, in an eighth possible implementation of the first aspect,

the location of the starting device for transmitting the first information is within a network coverage area or outside a network coverage area.

According to a sixth aspect, an embodiment of the present invention provides an information transmission method, which is applied to a device to device D2D scenario, and includes:

receiving, by a second device, first information when a relay level of the first information is a preset level or an information source of the first information is a preset source, where the relay level of the first information is used to indicate a quantity of relay devices that the first information has passed by before being transmitted to the second device, and the information source of the first information is used to indicate a location of a starting device for transmitting the first information;

generating, by the second device, a first scrambling sequence according to a first scrambling seed, where the first scrambling seed is generated according to the relay level or information source of the first information; and

descrambling, by the second device, the first information according to the first scrambling sequence.

With reference to the sixth aspect, in a first possible implementation, the method further includes:

generating, by the second device, a second scrambling sequence according to a second scrambling seed, where the second scrambling seed is generated according to a relay level or an information source of second information, the relay level of the second information is used to indicate a quantity of relay devices that the second information has passed by before being transmitted to a receive end, and the information source of the second information is used to indicate a location of a starting device for transmitting the second information; and

scrambling, by the second device, the second information according to the second scrambling sequence, and sending the second information.

With reference to the sixth aspect, in a second possible implementation of the sixth aspect,

when the first scrambling seed indicates the relay level of the first information,

after the descrambling, by the second device, the first information according to the first scrambling sequence, the method further includes:

using, by the second device, the relay level of the first information plus 1 as a new relay level of the first information, generating a third scrambling seed according to the new relay level of the first information, and generating a third scrambling sequence according to the third scrambling seed; and

scrambling, by the second device, the first information according to the third scrambling sequence, and sending the first information.

With reference to any one of the sixth aspect, or the first or the second possible implementation of the sixth aspect, in a third possible implementation of the sixth aspect,

N bits in the first scrambling seed are used to indicate the relay level or information source of the first information, and N is an integer greater than 0.

With reference to any one of the sixth aspect, or the first to the third possible implementations of the sixth aspect, in a fourth possible implementation of the sixth aspect,

the first scrambling seed includes a physical layer identity ID, and the physical layer ID is used to indicate the relay level or information source of the first information.

With reference to the fourth possible implementation of the sixth aspect, in a fifth possible implementation of the sixth aspect, the physical layer ID is used to indicate the relay level of the first information; and

when a sequence of the physical layer ID included in the first scrambling seed is a first sequence, the relay level of the first information is 0; when the sequence of the physical layer ID included in the first scrambling seed is an (i+1)^{th} sequence, the relay level of the first information is i, where i is a positive integer.

With reference to the fourth possible implementation of the sixth aspect, in a sixth possible implementation of the sixth aspect, the physical layer ID is used to indicate the relay level of the first information; and

when an offset of the physical layer ID included in the first scrambling seed is a first offset, the relay level of the first information is 0; when the offset of the physical layer ID included in the first scrambling seed is an (i+1)^{th} offset, the relay level of the first information is i, where i is a positive integer.

With reference to any one of the sixth aspect, or the first to the sixth possible implementations of the sixth aspect, in a seventh possible implementation of the sixth aspect,

the first information is control signaling, data information, or a discovery signal.

With reference to any one of the first aspect, or the first to the seventh possible implementations of the first aspect, in an eighth possible implementation of the first aspect,

the location of the starting device for transmitting the first information is within a network coverage area or outside a network coverage area.

According to a seventh aspect, an embodiment of the present invention provides a wireless network system, which is applied to a device to device D2D scenario, and includes a first device and a second device, where

the first device is the first device according to the first aspect or any possible implementation of the first aspect, and the second device is the second device according to the second aspect or any possible implementation of the second aspect; or

the first device is the first device according to the third aspect or any possible implementation of the third aspect, and the second device is the second device according to the fourth aspect or any possible implementation of the fourth aspect.

According to the information transmission method, the device, and the system that are provided in the embodiments of the present invention, a first device generates a first scrambling sequence according to a first scrambling seed, scrambles first information according to the first scrambling sequence, and sends the first information, where the first scrambling seed is generated according to a relay level or an information source of the first information. Because the first scrambling seed indicates the relay level or information source of the first information, information of different relay levels or from different information sources but with same information content can be forwarded only once, avoiding repeated sending, and saving channel resources. This resolves a problem in the prior art that in a D2D scenario, a terminal device cannot perform D2D communication due to a relatively long distance or a relatively significant change in channel quality.

### BRIEF DESCRIPTION OF DRAWINGS

To describe the technical solutions in the embodiments of the present invention or in the prior art more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic flowchart of an information transmission method according to an embodiment of the present invention;

FIG. 2 is a schematic diagram of a data structure of a scrambling seed according to an embodiment of the present invention;

FIG. 3 is a schematic flowchart of another information transmission method according to an embodiment of the present invention;

FIG. 4 is a schematic diagram of a network architecture of a D2D scenario according to an embodiment of the present invention;

FIG. 5 is a schematic flowchart of an information transmission method according to another embodiment of the present invention;

FIG. 6 is a schematic structural diagram of a first device according to an embodiment of the present invention;

FIG. 7 is a schematic structural diagram of a second device according to an embodiment of the present invention;

FIG. 8 is a schematic structural diagram of a first device according to another embodiment of the present invention;

FIG. 9 is a schematic structural diagram of a second device according to another embodiment of the present invention; and

FIG. 10 is a schematic structural diagram of a wireless network system according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

It should be understood that, the technical solutions of the embodiments of the present invention may be applied to various communications systems, such as: a Global System for Mobile Communications (Global System of Mobile communication, GSM) system, a Code Division Multiple Access (Code Division Multiple Access, CDMA) system, a Wideband Code Division Multiple Access (Wideband Code Division Multiple Access, WCDMA) system, a general packet radio service (General Packet Radio Service, GPRS), a Long Term Evolution (Long Term Evolution, LTE) system, an LTE frequency division duplex (Frequency Division Duplex, FDD) system, LTE time division duplex (Time Division Duplex, TDD), Universal Mobile Telecommunications System (Universal Mobile Telecommunications System, UMTS), or a Worldwide Interoperability for Microwave Access (Worldwide Interoperability for Microwave Access, WiMAX) communications system.

It should be understood that, a first device or a second device in the embodiments of the present invention may be a mobile phone (or referred to as a “cellular” phone), or a computer having a wireless communication function. Alternatively, the user equipment may be a portable, pocket-sized, handheld, computer built-in, or in-vehicle mobile apparatus.

In the embodiments of the present invention, “first” and “second” are only used for distinguishing, and are not intended to limit the embodiments of the present invention. The first device can execute a method of the second device, and the second device can also execute a method of the first device. Similarly, first information and second information in the embodiments of the present invention are also only used for distinguishing. Functions performed by using the first information can also be performed by using the second information. This is not limited in the present invention.

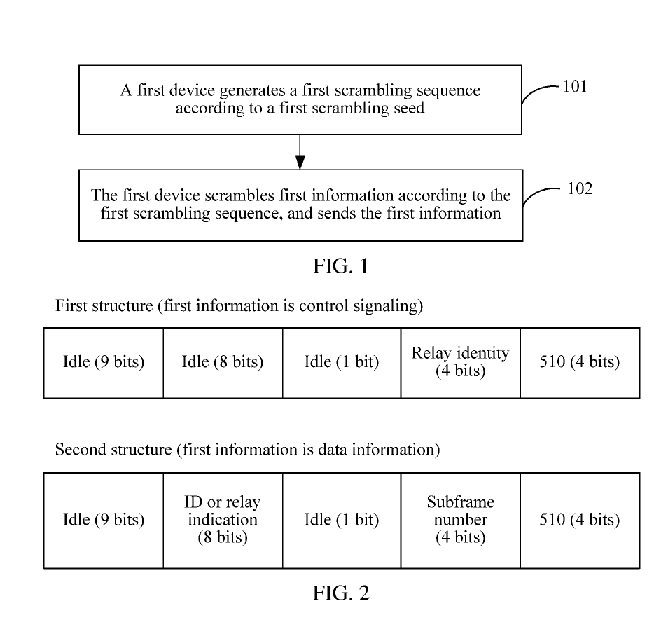

An embodiment of the present invention provides an information transmission method, which is applied to a D2D (Device to Device, device to device) scenario. As shown in FIG. 1, the method includes the following steps.

101: A first device generates a first scrambling sequence according to a first scrambling seed.

The first scrambling seed is generated according to a relay level or an information source of first information. The relay level of the first information is used to indicate a quantity of relay devices that the first information has passed by before being transmitted to a receive end. The information source of the first information is used to indicate a location of a starting device for transmitting the first information. It should be noted that, when the first device is the starting device for transmitting the first information, the relay level of the first information is 0. In addition, the location of the starting device for transmitting the first information described herein is within a network coverage area or outside a network coverage area. For example, the location of the starting device for transmitting the first information may be in a cell or out of a cell. A method of defining the location of the starting device is not limited in the present invention.

Optionally, the first information may be control signaling or data information. As shown in FIG. 2, FIG. 2 shows a structure of the first scrambling seed. A first structure is a structure of the first scrambling seed when the first information is the control signaling, and a second structure is a structure of the first scrambling seed when the first information is the data information. N bits in the first scrambling seed can be used to indicate the relay level or information source of the first information, where N is an integer greater than 0. For example, when one bit is used to indicate the information source, 0 indicates that the location of the starting device for transmitting the first information is in a cell, and 1 indicates that the location of the starting device is out of a cell. For another example, when two bits are used to indicate the relay level of the first information, “00” indicates that the relay level of the first information is 0, “01” indicates that the relay level of the first information is 1, “10” indicates that the relay level of the first information is 2, and “11” indicates that the relay level of the first information is 4. Certainly, these are only examples for description and do not mean that the present invention is limited thereto.

Alternatively, optionally, the first scrambling seed includes a physical layer ID (Identity, identity), and the physical layer ID is used to indicate the relay level or information source of the first information.

Specifically optionally, in an application scenario, the first scrambling seed may indicate the relay level of the first information. That the physical layer ID indicates the relay level of the first information is used as an example.

When a sequence of the physical layer ID included in a first scrambling seed is the first sequence, the relay level of the first information is 0; when the sequence of the physical layer ID included in the first scrambling seed is an (i+1)^{th} sequence, the relay level of the first information is i, where i is a positive integer.

Alternatively, when an offset of the physical layer ID included in a first scrambling seed is the first offset, the relay level of the first information is 0; when the offset of the physical layer ID included in the first scrambling seed is an (i+1)^{th} offset, the relay level of the first information is i, where i is a positive integer.

Certainly, this is only an example for description and does not mean that the present invention is limited thereto.

102: The first device scrambles first information according to the first scrambling sequence, and sends the first information.

Optionally, after step 102, the method may further include:

receiving, by the first device, second information when a relay level of the second information is a preset level or an information source of the second information is a preset source, where the relay level of the second information is used to indicate a quantity of relay devices that the second information has passed by before being transmitted to the first device, and the information source of the second information is used to indicate a location of a starting device for transmitting the second information;

generating, by the first device, a second scrambling sequence according to a second scrambling seed, where the second scrambling seed is generated according to the relay level or information source of the second information; and

descrambling, by the first device, the second information according to the second scrambling sequence.

Further optionally, when the second scrambling seed indicates the relay level of the second information, after the descrambling, by the first device, the second information according to the second scrambling sequence, the method further includes:

using, by the first device, the relay level of the second information plus 1 as a new relay level of the second information, generating a third scrambling seed according to the new relay level of the second information, and generating a third scrambling sequence according to the third scrambling seed; and

scrambling, by the first device, the second information according to the third scrambling sequence, and sending the second information.

According to the information transmission method provided in this embodiment of the present invention, a first device generates a first scrambling sequence according to a first scrambling seed, scrambles first information according to the first scrambling sequence, and sends the first information, where the first scrambling seed is generated according to a relay level or an information source of the first information. Because the first scrambling seed indicates the relay level or information source of the first information, information of different relay levels or from different information sources but with same information content can be forwarded only once, avoiding repeated transmissions and saving channel resources. This resolves a problem in the prior art that in a D2D scenario, a terminal device cannot perform D2D communication due to a relatively long distance or a relatively significant change in channel quality.

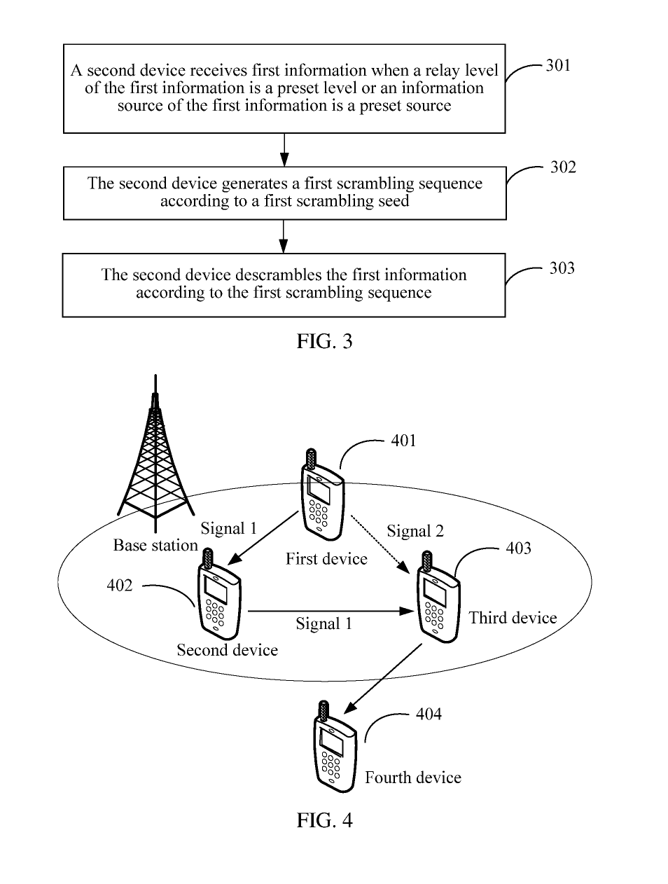

With reference to the embodiment corresponding to FIG. 1, an embodiment of the present invention provides another information transmission method, which corresponds to a receive side of the information transmission method in the embodiment corresponding to FIG. 1. As shown in FIG. 3, the method includes the following steps.

301: A second device receives first information when a relay level of the first information is a preset level or an information source of the first information is a preset source.

The relay level of the first information is used to indicate a quantity of relay devices that second information has passed by before being transmitted to the second device. The information source of the first information is used to indicate a location of a starting device for transmitting the first information.

It should be noted that, the second device first temporarily stores all or a part of the first information, and then descrambles the temporarily stored part. A scrambling seed used during descrambling is generated according to a preset level or preset source. If descrambling is correctly performed, it indicates that the relay level of the first information is a preset level or the information source of the first information is a preset source. In this case, the second device can receive the remaining part of the first information or descramble all temporarily stored first information. Optionally, the second device may be a destination device or relay device for transmission of the first information. The preset level is a preset relay level, and the preset source is a preset information source. In this way, the second device only receives information whose relay level is the preset level or whose information source is the preset source. Information of different relay levels but with same content or information from different information sources but with same content is received only once, avoiding repeatedly receiving same information.

It should be noted that, using a D2D scenario in an LTE (Long Term Evolution, Long Term Evolution) system as an example, as shown in FIG. 4, if a first device 401 needs to transmit data to a second device 402 by using a third device 403 and a fourth device 404, the first device 401 needs to use an SA (Scheduling Assignment, scheduling assignment) resource to send scheduling signaling and use a data resource to send a corresponding D2D signal. The scheduling signaling includes a destination address, that is, an address of the second device. In this way, the first device 401 sends a signal 1 within a first time period and then sends a signal 2 within a second time period. The first time period is adjacent to the second time period. The third device 403 receives the signal 1 within the first time period and then sends the signal 1 within the second time period. In this way, the fourth device 404 can receive, within the second time period, the signal 2 sent by the first device 401 and the signal 1 sent by the third device 403. Because destination addresses of both the signals are the second device 402, a sequence relationship between data carried by the two signals cannot be identified. As a result, an error occurs during data receiving. However, in the information transmission method provided in this embodiment of the present invention, the second device 402 only receives a signal of a preset level. Therefore, for signals of a same relay level, a sequence relationship is not mired in confusion. This avoids a problem that an error occurs during data receiving because a sequence relationship between different signals cannot be identified. In addition, information of different relay levels but with same content is received only once, avoiding repeated receiving.

302: The second device generates a first scrambling sequence according to a first scrambling seed.

The first scrambling seed is generated according to the relay level or information source of the first information.

Optionally, the first information may be control signaling or data information, and N bits in the first scrambling seed can be used to indicate the relay level or information source of the first information, where N is an integer greater than 0.

Alternatively, optionally, the first scrambling seed includes a physical layer ID, and the physical layer ID is used to indicate the relay level or information source of the first information.

Specifically optionally, in an application scenario, the first scrambling seed may indicate the relay level of the first information. That the physical layer ID indicates the relay level of the first information is used as an example.

When a sequence of the physical layer ID included in a first scrambling seed is the first sequence, the relay level of the first information is 0; when the sequence of the physical layer ID included in the first scrambling seed is an (i+1)^{th} sequence, the relay level of the first information is i, where i is a positive integer.

Alternatively, when an offset of the physical layer ID included in a first scrambling seed is the first offset, the relay level of the first information is 0; when the offset of the physical layer ID included in the first scrambling seed is an (i+1)^{th} offset, the relay level of the first information is i, where i is a positive integer.

Certainly, this is only an example for description and does not mean that the present invention is limited thereto.

303: The second device descrambles the first information according to the first scrambling sequence.

Optionally, when the first scrambling seed indicates the relay level of the first information, after step 303, the method further includes:

using, by the second device, the relay level of the first information plus 1 as a new relay level of the first information, generating a third scrambling seed according to the new relay level of the first information, and generating a third scrambling sequence according to the third scrambling seed; and

scrambling, by the second device, the first information according to the third scrambling sequence, and sending the first information.

In addition, optionally, the second device may further generate a second scrambling sequence according to a second scrambling seed. The second scrambling seed is generated according to a relay level or an information source of second information, the relay level of the second information is used to indicate a quantity of relay devices that the second information has passed by before being transmitted to a receive end, and the information source of the second information is used to indicate a location of a starting device for transmitting the second information.

The second device scrambles the second information according to the second scrambling sequence, and sends the second information.

According to the information transmission method provided in this embodiment of the present invention, a second device receives first information when a relay level of the first information is a preset level or an information source of the first information is a preset source, generates a first scrambling sequence according to a first scrambling seed, and descrambles the first information according to the first scrambling sequence, where the first scrambling seed is generated according to the relay level or information source of the first information. Because the first scrambling seed indicates the relay level or information source of the first information, information of different relay levels or from different information sources but with same information content can be forwarded only once, avoiding repeated transmissions and saving channel resources. This resolves a problem in the prior art that in a D2D scenario, a terminal device cannot perform D2D communication due to a relatively long distance or a relatively significant change in channel quality.

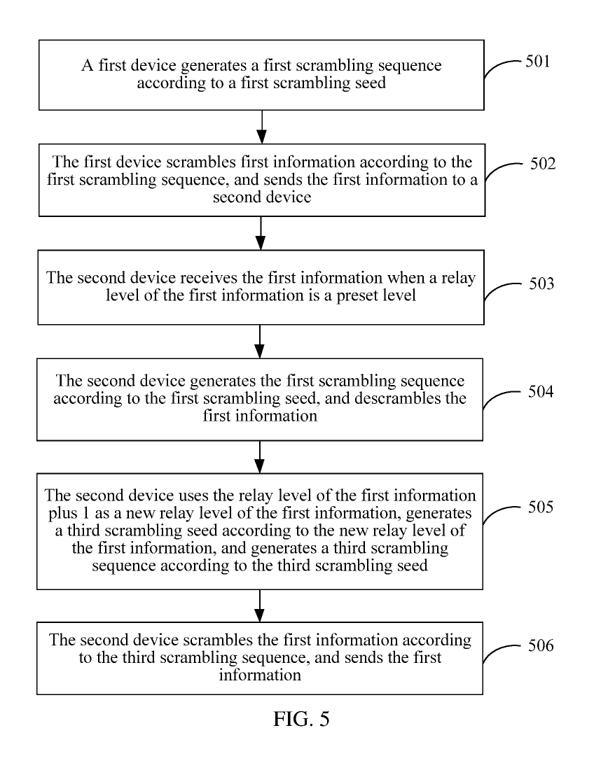

Based on the embodiments corresponding to FIG. 1 and FIG. 2, another embodiment of the present invention provides an information transmission method. In this embodiment, that a first device and a second device are relay devices is used as an example for description. The first device may execute a method of the second device, and the second device may execute a method of the first device. The first device and the second device are only used for distinguishing and are not intended to limit functions performed by the first device and the second device. Certainly, this embodiment is only used as an example for description and does not mean that the present invention is limited thereto. As shown in FIG. 5, the information transmission method provided in this embodiment of the present invention includes the following steps.

501: The first device generates a first scrambling sequence according to a first scrambling seed.

The first scrambling seed is generated according to a relay level or an information source of first information. The relay level of the first information is used to indicate a quantity of relay devices that the first information has passed by before being transmitted to a receive end. The information source of the first information is used to indicate a location of a starting device for transmitting the first information. It should be noted that, when the first device is the starting device for transmitting the first information, the relay level of the first information is 0. In addition, the location of the starting device for transmitting the first information described herein may be in a cell or out of a cell. A method of defining the location of the starting device is not limited in the present invention.

502: The first device scrambles first information according to the first scrambling sequence, and sends the first information to the second device.

It should be noted that, in this embodiment, that the first scrambling seed indicates the relay level of the first information is used as an example for description. Certainly, this is only an example for description and does not mean that the present invention is limited thereto.

503: The second device receives the first information when a relay level of the first information is a preset level.

504: The second device generates the first scrambling sequence according to the first scrambling seed, and descrambles the first information.

505: The second device uses the relay level of the first information plus 1 as a new relay level of the first information, generates a third scrambling seed according to the new relay level of the first information, and generates a third scrambling sequence according to the third scrambling seed.

506: The second device scrambles the first information according to the third scrambling sequence, and sends the first information.

According to the information transmission method provided in this embodiment of the present invention, a first device generates a first scrambling sequence according to a first scrambling seed, scrambles first information according to the first scrambling sequence, and sends the first information, where the first scrambling seed is generated according to a relay level or an information source of the first information. Because the first scrambling seed indicates the relay level or information source of the first information, information of different relay levels or from different information sources but with same information content can be forwarded only once, avoiding repeated transmissions and saving channel resources. This resolves a problem in the prior art that in a D2D scenario, a terminal device cannot perform D2D communication due to a relatively long distance or a relatively significant change in channel quality.

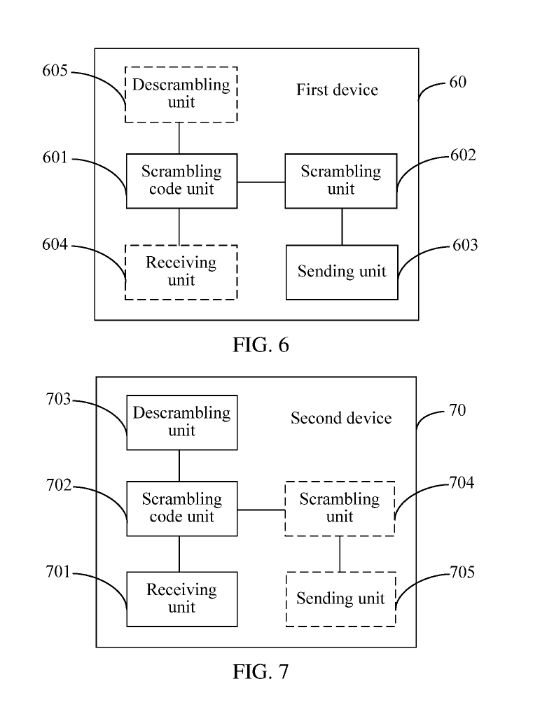

Based on the embodiment corresponding to FIG. 1, an embodiment of the present invention provides a first device, configured to execute the information transmission method described in the embodiment corresponding to FIG. 1, and preferably applied to a device to device D2D scenario. As shown in FIG. 6, the first device 60 includes a scrambling code unit 601, a scrambling unit 602, and a sending unit 603.

The scrambling code unit 601 is configured to generate a first scrambling sequence according to a first scrambling seed. The first scrambling seed is generated according to a relay level or an information source of first information, the relay level of the first information is used to indicate a quantity of relay devices that the first information has passed by before being transmitted to a receive end, and the information source of the first information is used to indicate a location of a starting device for transmitting the first information. Optionally, the location of the starting device for transmitting the first information is within a network coverage area or outside a network coverage area.

The scrambling unit 602 is configured to scramble the first information according to the first scrambling sequence generated by the scrambling code unit 601.

The sending unit 603 is configured to send the first information scrambled by the scrambling unit 602.

Optionally, in an application scenario, the first device 60 further includes a receiving unit 604 and a descrambling unit 605.

The receiving unit 604 is configured to receive second information when a relay level of the second information is a preset level or an information source of the second information is a preset source. The relay level of the second information is used to indicate a quantity of relay devices that the second information has passed by before being transmitted to the first device, and the information source of the second information is used to indicate a location of a starting device for transmitting the second information.

The scrambling code unit 601 is further configured to generate a second scrambling sequence according to a second scrambling seed.

The descrambling unit 605 is configured to descramble, according to the second scrambling sequence generated by the scrambling code unit 601, the second information received by the receiving unit. The second scrambling seed is generated according to the relay level or information source of the second information received by the receiver.

Further optionally, the scrambling code unit 601 is further configured to: when the second scrambling seed indicates the relay level of the second information, use the relay level of the second information plus 1 as a new relay level of the second information, generate a third scrambling seed according to the new relay level of the second information, and generate a third scrambling sequence according to the third scrambling seed.

The scrambling unit 602 is configured to scramble the second information according to the third scrambling sequence generated by the scrambling code unit 601.

The sending unit 603 is further configured to send the second information scrambled by the scrambling unit 602.

Optionally, N bits in the first scrambling seed may be used to indicate the relay level or information source of the first information, and N is an integer greater than 0.

Optionally, the first scrambling seed may alternatively include a physical layer identity ID, and the physical layer ID is used to indicate the relay level or information source of the first information.

If the physical layer ID is used to indicate the relay level of the first information, two specific implementations are listed herein for description:

Implementation 1: When a sequence of the physical layer ID included in a first scrambling seed is the first sequence, the relay level of the first information is 0; when the sequence of the physical layer ID included in the first scrambling seed is an (i+1)^{th} sequence, the relay level of the first information is i, where i is a positive integer.

Implementation 2: When an offset of the physical layer ID included in a first scrambling seed is the first offset, the relay level of the first information is 0; when the offset of the physical layer ID included in the first scrambling seed is an (i+1)^{th} offset, the relay level of the first information is i, where i is a positive integer.

Optionally, the first information is control signaling, data information, or a discovery signal.

The first device provided in this embodiment of the present invention generates a first scrambling sequence according to a first scrambling seed, scrambles first information according to the first scrambling sequence, and sends the first information, where the first scrambling seed is generated according to a relay level or an information source of the first information. Because the first scrambling seed indicates the relay level or information source of the first information, information of different relay levels or from different information sources but with same information content can be forwarded only once, avoiding repeated transmissions and saving channel resources. This resolves a problem in the prior art that in a D2D scenario, a terminal device cannot perform D2D communication due to a relatively long distance or a relatively significant change in channel quality.

Based on the embodiment corresponding to FIG. 3, an embodiment of the present invention provides a second device, configured to execute the information transmission method described in the embodiment corresponding to FIG. 3, and preferably applied to a device to device D2D scenario. As shown in FIG. 7, the second device 70 includes a receiving unit 701, a scrambling code unit 702, and a descrambling unit 703.

The receiving unit 701 is configured to receive first information when a relay level of the first information is a preset level or an information source of the first information is a preset source. The relay level of the first information is used to indicate a quantity of relay devices that the first information has passed by before being transmitted to the second device. The information source of the first information is used to indicate a location of a starting device for transmitting the first information. Optionally,

the location of the starting device for transmitting the first information is within a network coverage area or outside a network coverage area.

The scrambling code unit 702 is configured to generate a first scrambling sequence according to a first scrambling seed. The first scrambling seed is generated according to the relay level or information source of the first information.

The descrambling unit 703 is configured to descramble the first information according to the first scrambling sequence generated by the scrambling code unit 702.

Optionally, the second device 70 further includes a scrambling unit 704 and a sending unit 705.

Optionally, in an application scenario:

The scrambling code unit 702 is further configured to generate a second scrambling sequence according to a second scrambling seed. The second scrambling seed is generated according to a relay level or an information source of second information, the relay level of the second information is used to indicate a quantity of relay devices that the second information has passed by before being transmitted to a receive end, and the information source of the second information is used to indicate a location of a starting device for transmitting the second information.

The scrambling unit 704 is configured to scramble the second information according to the second scrambling sequence generated by the scrambling code unit 702.

The sending unit 705 is configured to send the second information scrambled by the scrambling unit 704.

Optionally, in another application scenario:

The scrambling code unit 702 is further configured to: when the first scrambling seed indicates the relay level of the first information, use the relay level of the first information plus 1 as a new relay level of the first information, generate a third scrambling seed according to the new relay level of the first information, and generate a third scrambling sequence according to the third scrambling seed.

The scrambling unit 704 is configured to scramble the first information according to the third scrambling sequence generated by the scrambling code unit 702.

The sending unit 705 is configured to send the first information scrambled by the scrambling unit 704.

Optionally, N bits in the first scrambling seed may be used to indicate the relay level or information source of the first information, and N is an integer greater than 0.

Optionally, the first scrambling seed may alternatively include a physical layer identity ID, and the physical layer ID is used to indicate the relay level or information source of the first information.

If the physical layer ID is used to indicate the relay level of the first information, two specific implementations are listed herein for description:

Implementation 1: When a sequence of the physical layer ID included in a first scrambling seed is the first sequence, the relay level of the first information is 0; when the sequence of the physical layer ID included in the first scrambling seed is an (i+1)^{th} sequence, the relay level of the first information is i, where i is a positive integer.

Implementation 2: When an offset of the physical layer ID included in a first scrambling seed is the first offset, the relay level of the first information is 0; when the offset of the physical layer ID included in the first scrambling seed is an (i+1)^{th} offset, the relay level of the first information is i, where i is a positive integer.

Optionally, the first information is control signaling, data information, or a discovery signal.

The second device provided in this embodiment of the present invention receives first information when a relay level of the first information is a preset level or an information source of the first information is a preset source, generates a first scrambling sequence according to a first scrambling seed, and descrambles the first information according to the first scrambling sequence, where the first scrambling seed is generated according to the relay level or information source of the first information. Because the first scrambling seed indicates the relay level or information source of the first information, information of different relay levels or from different information sources but with same information content can be forwarded only once, avoiding repeated transmissions and saving channel resources. This resolves a problem in the prior art that in a D2D scenario, a terminal device cannot perform D2D communication due to a relatively long distance or a relatively significant change in channel quality.

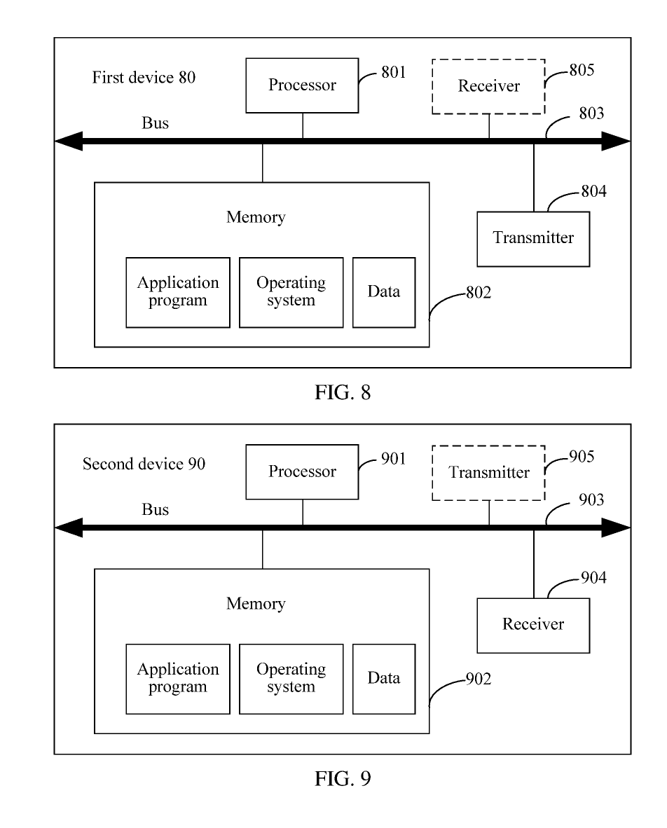

Based on the embodiment corresponding to FIG. 1, another embodiment of the present invention provides a first device, configured to execute the information transmission method described in the embodiment corresponding to FIG. 1, and preferably applied to a device to device D2D scenario. As shown in FIG. 8, the first device 80 includes at least one processor 801, a memory 802, a bus 803, and a transmitter 804. The at least one processor 801, the memory 802, and the transmitter 804 are connected and communicate with each other by using the bus 803.

The bus 803 may be an ISA (Industry Standard Architecture, industry standard architecture) bus, a PCI (Peripheral Component, peripheral component interconnect) bus, an EISA (Extended Industry Standard Architecture, extended industry standard architecture) bus, or the like. The bus 803 may be classified into an address bus, a data bus, a control bus, and the like. For convenience of representation, only one bold line is used for representation in FIG. 8, but it does not represent that there is only one bus or one type of bus.

The memory 802 is used for application program code for executing the solution of the present invention. The application program code for executing the solution of the present invention is stored in the memory, and is controlled and executed by the processor 801.

The memory may be a read-only memory ROM or another type of static storage device that can store static information and an instruction; a random access memory RAM or another type of dynamic storage device that can store information and an instruction; or an electrically erasable programmable read-only memory EEPROM, a compact disc read-only memory CD-ROM or another compact-disc memory, an optical disc (including compressed disc, laser disk, optical disc, digital general optical disc, Blu-ray disc, or the like) memory, a magnetic disk storage medium or another magnetic storage device, or any other media that can be used to carry or store expected program code in the form of an instruction or a data structure and can be accessed by a computer, but is not limited thereto. These memories are connected to the processor by using the bus.

The processor 801 may be a central processing unit 801 (Central Processing Unit, CPU for short), an application-specific integrated circuit (Application Specific Integrated Circuit, ASIC for short), or one or more integrated circuits configured to implement this embodiment of the present invention.

The processor 801 is configured to: generate a first scrambling sequence according to a first scrambling seed, and scramble first information according to the first scrambling sequence. The first scrambling seed is generated according to a relay level or an information source of the first information, the relay level of the first information is used to indicate a quantity of relay devices that the first information has passed by before being transmitted to a receive end, and the information source of the first information is used to indicate a location of a starting device for transmitting the first information.

The transmitter 804 is configured to send the first information scrambled by the processor 801.

Optionally, in an application scenario, the first device 80 further includes a receiver 805. The receiver 805 is interconnected to the processor 801, the memory 802, and the transmitter 804 by using the bus 803.

The receiver 805 is configured to receive second information when a relay level of the second information is a preset level or an information source of the second information is a preset source. The relay level of the second information is used to indicate a quantity of relay devices that the second information has passed by before being transmitted to the first device, and the information source of the second information is used to indicate a location of a starting device for transmitting the second information. Optionally, the location of the starting device for transmitting the first information is within a network coverage area or outside a network coverage area.

The processor 801 is further configured to: generate a second scrambling sequence according to a second scrambling seed, and descramble the second information according to the second scrambling sequence. The second scrambling seed is generated according to the relay level or information source of the second information received by the receiver 805.

Further optionally, the processor 801 is further configured to: when the second scrambling seed indicates the relay level of the second information, use the relay level of the second information plus 1 as a new relay level of the second information, generate a third scrambling seed according to the new relay level of the second information, and generate a third scrambling sequence according to the third scrambling seed; and scramble the second information according to the third scrambling sequence.

The transmitter 804 is further configured to send the second information scrambled by the processor 801.

Optionally, N bits in the first scrambling seed may be used to indicate the relay level or information source of the first information, and N is an integer greater than 0.

Optionally, the first scrambling seed may alternatively include a physical layer identity ID, and the physical layer ID is used to indicate the relay level or information source of the first information.

If the physical layer ID is used to indicate the relay level of the first information, two specific implementations are listed herein for description:

Implementation 1: When a sequence of the physical layer ID included in a first scrambling seed is the first sequence, the relay level of the first information is 0; when the sequence of the physical layer ID included in the first scrambling seed is an (i+1)^{th} sequence, the relay level of the first information is i, where i is a positive integer.

Implementation 2: When an offset of the physical layer ID included in a first scrambling seed is the first offset, the relay level of the first information is 0; when the offset of the physical layer ID included in the first scrambling seed is an (i+1)^{th} offset, the relay level of the first information is i, where i is a positive integer.

Optionally, the first information is control signaling, data information, or a discovery signal.

The first device provided in this embodiment of the present invention generates a first scrambling sequence according to a first scrambling seed, scrambles first information according to the first scrambling sequence, and sends the first information, where the first scrambling seed is generated according to a relay level or an information source of the first information. Because the first scrambling seed indicates the relay level or information source of the first information, information of different relay levels or from different information sources but with same information content can be forwarded only once, avoiding repeated transmissions and saving channel resources. This resolves a problem in the prior art that in a D2D scenario, a terminal device cannot perform D2D communication due to a relatively long distance or a relatively significant change in channel quality.

Based on the embodiment corresponding to FIG. 3, another embodiment of the present invention provides a second device, configured to execute the information transmission method described in the embodiment corresponding to FIG. 3, and preferably applied to a device to device D2D scenario. As shown in FIG. 9, the second device 90 includes at least one processor 901, a memory 902, a bus 903, and a receiver 904. The at least one processor 901, the memory 902, and the receiver 904 are connected and communicate with each other by using the bus 903.

The bus 903 may be an ISA (Industry Standard Architecture, industry standard architecture) bus, a PCI (Peripheral Component, peripheral component interconnect) bus, an EISA (Extended Industry Standard Architecture, extended industry standard architecture) bus, or the like. The bus 903 may be classified into an address bus, a data bus, a control bus, and the like. For convenience of representation, only one bold line is used for representation in FIG. 9, but it does not represent that there is only one bus or one type of bus.

The memory 902 is used for application program code for executing the solution of the present invention. The application program code for executing the solution of the present invention is stored in the memory, and is controlled and executed by the processor 901.

The memory may be a read-only memory ROM or another type of static storage device that can store static information and an instruction; a random access memory RAM or another type of dynamic storage device that can store information and an instruction; or an electrically erasable programmable read-only memory EEPROM, a compact disc read-only memory CD-ROM or another compact-disc memory, an optical disc (including compressed disc, laser disk, optical disc, digital general optical disc, Blu-ray disc, or the like) memory, a magnetic disk storage medium or another magnetic storage device, or any other media that can be used to carry or store expected program code in the form of an instruction or a data structure and can be accessed by a computer, but is not limited thereto. These memories are connected to the processor by using the bus.

The processor 901 may be a central processing unit 901 (Central Processing Unit, CPU for short), an application-specific integrated circuit (Application Specific Integrated Circuit, ASIC for short), or one or more integrated circuits configured to implement this embodiment of the present invention.

The receiver 904 is configured to receive first information when a relay level of the first information is a preset level or an information source of the first information is a preset source. The relay level of the first information is used to indicate a quantity of relay devices that the first information has passed by before being transmitted to the second device. The information source of the first information is used to indicate a location of a starting device for transmitting the first information. Optionally, the location of the starting device for transmitting the first information is within a network coverage area or outside a network coverage area.

The processor 901 is configured to: generate a first scrambling sequence according to a first scrambling seed, and descramble the first information according to the first scrambling sequence. The first scrambling seed is generated according to the relay level or information source of the first information.

Optionally, the second device 90 further includes a transmitter 905. The transmitter 905 is interconnected to the processor 901, the memory 902, and the transmitter 905 by using the bus 903.

Optionally, in an application scenario:

The processor 901 is further configured to: generate a second scrambling sequence according to a second scrambling seed, and scramble second information according to the second scrambling sequence. The second scrambling seed is generated according to a relay level or an information source of the second information, the relay level of the second information is used to indicate a quantity of relay devices that the second information has passed by before being transmitted to a receive end, and the information source of the second information is used to indicate a location of a starting device for transmitting the second information.

The transmitter 905 is configured to send the second information scrambled by the processor 901.

Optionally, in another application scenario:

The processor 901 is further configured to: when the first scrambling seed indicates the relay level of the first information, use the relay level of the first information plus 1 as a new relay level of the first information, generate a third scrambling seed according to the new relay level of the first information, and generate a third scrambling sequence according to the third scrambling seed; and scramble the first information according to the third scrambling sequence.

The transmitter 905 is configured to send the first information scrambled by the processor 901.

Optionally, N bits in the first scrambling seed may be used to indicate the relay level or information source of the first information, and N is an integer greater than 0.

Optionally, the first scrambling seed may alternatively include a physical layer identity ID, and the physical layer ID is used to indicate the relay level or information source of the first information.

If the physical layer ID is used to indicate the relay level of the first information, two specific implementations are listed herein for description:

Implementation 1: When a sequence of the physical layer ID included in a first scrambling seed is the first sequence, the relay level of the first information is 0; when the sequence of the physical layer ID included in the first scrambling seed is an (i+1)^{th} sequence, the relay level of the first information is i, where i is a positive integer.

Implementation 2: When an offset of the physical layer ID included in a first scrambling seed is the first offset, the relay level of the first information is 0; when the offset of the physical layer ID included in the first scrambling seed is an (i+1)^{th} offset, the relay level of the first information is i, where i is a positive integer.

Optionally, the first information is control signaling, data information, or a discovery signal.

The second device provided in this embodiment of the present invention receives first information when a relay level of the first information is a preset level or an information source of the first information is a preset source, generates a first scrambling sequence according to a first scrambling seed, and descrambles the first information according to the first scrambling sequence, where the first scrambling seed is generated according to the relay level or information source of the first information. Because the first scrambling seed indicates the relay level or information source of the first information, information of different relay levels or from different information sources but with same information content can be forwarded only once, avoiding repeated transmissions and saving channel resources. This resolves a problem in the prior art that in a D2D scenario, a terminal device cannot perform D2D communication due to a relatively long distance or a relatively significant change in channel quality.

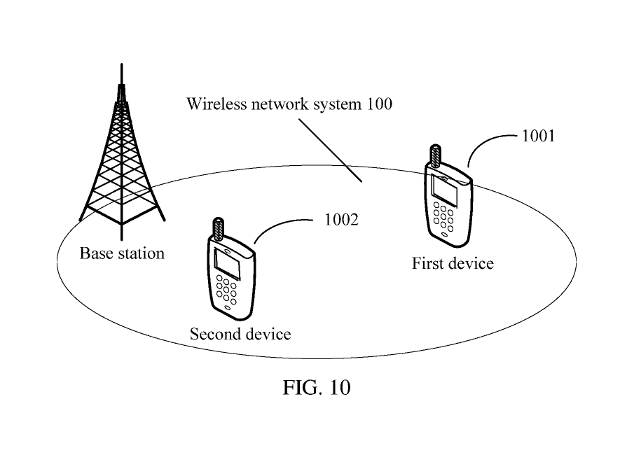

Based on the embodiments corresponding to FIG. 1, FIG. 3, and FIG. 5, an embodiment of the present invention provides a wireless network system, configured to execute the information transmission methods described in the embodiments corresponding to FIG. 1, FIG. 3, and FIG. 5. As shown in FIG. 10, the wireless network system 100 includes a first device 1001 and a second device 1002.

The first device 1001 is the first device described in the embodiment corresponding to FIG. 6, and the second device 1002 is the second device described in the embodiment corresponding to FIG. 7.

Alternatively, the first device 1001 is the first device described in the embodiment corresponding to FIG. 8, and the second device 1002 is the second device described in the embodiment corresponding to FIG. 9.

According to the wireless network system provided in this embodiment of the present invention, a first device generates a first scrambling sequence according to a first scrambling seed, scrambles first information according to the first scrambling sequence, and sends the first information, where the first scrambling seed is generated according to a relay level or an information source of the first information. Because the first scrambling seed indicates the relay level or information source of the first information, information of different relay levels or from different information sources but with same information content can be forwarded only once, avoiding repeated transmissions and saving channel resources. This resolves a problem in the prior art that in a D2D scenario, a terminal device cannot perform D2D communication due to a relatively long distance or a relatively significant change in channel quality.

With descriptions of the foregoing embodiments, a person skilled in the art may clearly understand that the present invention may be implemented by hardware, firmware or a combination thereof. When the present invention is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a computer. The following is taken as an example but is not limited: The computer readable medium may include a RAM (Random Access Memory, random access memory), a ROM (Read-Only Memory, read-only memory), an EEPROM (Electrically Erasable Programmable Read-Only Memory, electrically erasable programmable read-only memory), a CD-ROM (Compact Disc Read-Only Memory, compact disc read-only memory) or other optical disk storage, a disk storage medium or other disk storage, or any other medium that can be used to carry or store expected program code in a command or data structure form and can be accessed by a computer. In addition, any connection may be appropriately defined as a computer-readable medium. For example, if software is transmitted from a website, a server or another remote source by using a coaxial cable, an optical fiber/cable, a twisted pair, a DSL (Digital Subscriber Line, digital subscriber line) or wireless technologies such as infrared ray, radio and microwave, the coaxial cable, optical fiber/cable, twisted pair, DSL or wireless technologies such as infrared ray, radio and microwave are included in fixation of a medium to which they belong. For example, a disk and a disc used by the present invention includes a CD (Compact Disc, compact disc), a laser disc, an optical disc, a DVD disc (Digital Versatile Disc, digital versatile disc), a floppy disk and a Blu-ray disc, where the disk generally copies data by a magnetic means, and the disc copies data optically by a laser means. The foregoing combination should also be included in the protection scope of the computer-readable medium.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

1-36. (canceled)

37. An information transmission method, applied to a device to device (D2D) scenario, the method comprising:
generating, by a first device, a first scrambling sequence according to a first scrambling seed, wherein the first scrambling seed is generated according to a relay level or an information source of first information, the relay level of the first information for indicating a quantity of relay devices that the first information has passed by before being transmitted to a receive end, and the information source of the first information for indicating a location of a starting device for transmitting the first information; and
scrambling, by the first device, the first information according to the first scrambling sequence, and sending the first information.

38. The method according to claim 37, wherein the method further comprises:
receiving, by the first device, second information when a relay level of the second information is a preset level or an information source of the second information is a preset source, the relay level of the second information for indicating a quantity of relay devices that the second information has passed by before being transmitted to the first device, and the information source of the second information for indicating a location of a starting device for transmitting the second information;
generating, by the first device, a second scrambling sequence according to a second scrambling seed, wherein the second scrambling seed is generated according to the relay level or information source of the second information; and
descrambling, by the first device, the second information according to the second scrambling sequence.

39. The method according to claim 38, wherein when the second scrambling seed indicates the relay level of the second information, after descrambling, by the first device, the second information according to the second scrambling sequence, the method further comprises:
using, by the first device, the relay level of the second information plus 1 as a new relay level of the second information, generating a third scrambling seed according to the new relay level of the second information, and generating a third scrambling sequence according to the third scrambling seed; and
scrambling, by the first device, the second information according to the third scrambling sequence, and sending the second information.

40. The method according to claim 37, wherein:
N bits in the first scrambling seed indicate the relay level or information source of the first information, and N is an integer greater than 0.

41. The method according to claim 37, wherein the first scrambling seed comprises a physical layer identity ID for indicating the relay level or information source of the first information.

42. The method according to claim 41, wherein:
the physical layer ID indicates the relay level of the first information;
when a sequence of the physical layer ID comprised in the first scrambling seed is a first sequence, the relay level of the first information is 0; and
when the sequence of the physical layer ID comprised in the first scrambling seed is an (i+1)^{th} sequence, the relay level of the first information is i, wherein i is a positive integer.

43. The method according to claim 41, wherein:
the physical layer ID indicates the relay level of the first information;
when an offset of the physical layer ID comprised in the first scrambling seed is a first offset, the relay level of the first information is 0; and
when the offset of the physical layer ID comprised in the first scrambling seed is an (i+1)^{th} offset, the relay level of the first information is i, wherein i is a positive integer.

44. The method according to claim 37, wherein the first information is control signaling, data information, or a discovery signal.

45. The method according to claim 37, wherein the location of the starting device for transmitting the first information is within a network coverage area or outside a network coverage area.

46. An information transmission method, applied to a device to device (D2D) scenario, the method comprising:
receiving, by a second device, first information when a relay level of the first information is a preset level or an information source of the first information is a preset source, the relay level of the first information is for indicating a quantity of relay devices that the first information has passed by before being transmitted to the second device, and the information source of the first information for indicating a location of a starting device for transmitting the first information;
generating, by the second device, a first scrambling sequence according to a first scrambling seed, wherein the first scrambling seed is generated according to the relay level or information source of the first information; and
descrambling, by the second device, the first information according to the first scrambling sequence.

47. The method according to claim 46, wherein the method further comprises:
generating, by the second device, a second scrambling sequence according to a second scrambling seed, wherein the second scrambling seed is generated according to a relay level or an information source of second information, the relay level of the second information for indicating a quantity of relay devices that the second information has passed by before being transmitted to a receive end, and the information source of the second information for indicating a location of a starting device for transmitting the second information; and
scrambling, by the second device, the second information according to the second scrambling sequence, and sending the second information.

48. The method according to claim 46, wherein when the first scrambling seed indicates the relay level of the first information, after descrambling, by the second device, the first information according to the first scrambling sequence, the method further comprises:
using, by the second device, the relay level of the first information plus 1 as a new relay level of the first information, generating a third scrambling seed according to the new relay level of the first information, and generating a third scrambling sequence according to the third scrambling seed; and
scrambling, by the second device, the first information according to the third scrambling sequence, and sending the first information.

49. The method according to claim 46, wherein:
N bits in the first scrambling seed indicate the relay level or information source of the first information, and N is an integer greater than 0.

50. The method according to claim 46, wherein the first scrambling seed comprises a physical layer identity ID for indicating the relay level or information source of the first information.

51. The method according to claim 50, wherein:
the physical layer ID indicates the relay level of the first information;
when a sequence of the physical layer ID comprised in the first scrambling seed is a first sequence, the relay level of the first information is 0; and
when the sequence of the physical layer ID comprised in the first scrambling seed is an (i+1)^{th} sequence, the relay level of the first information is i, wherein i is a positive integer.

52. The method according to claim 50, wherein:
when an offset of the physical layer ID comprised in the first scrambling seed is a first offset, the relay level of the first information is 0; and
when the offset of the physical layer ID comprised in the first scrambling seed is an (i+1)^{th} offset, the relay level of the first information is i, wherein i is a positive integer.

53. The method according to claim 46, wherein the first information is control signaling, data information, or a discovery signal.

54. The method according to claim 46, wherein the location of the starting device for transmitting the first information is within a network coverage area or outside a network coverage area.

55. (canceled)
